(19) United States
(12) Patent Application Publication
(10) Pub. No.: US 2026/0296757 A1
(43) Pub. Date: Oct. 1, 2026

(54) ANTI-THEFT DEVICE FOR BLISTER PACKAGES AND THE LIKE

(71) Applicant: Industrial Security Solutions, Corp., Sparks, NV (US)

(72) Inventors: David Michael SANDOVAL, Reno, NV (US); Pengqiang HU, Lin'an (CN); Mingjun HU, Lin'an (CN); Jiakui CHEN, Lin'an (CN)

(21) Appl. No.: 19/575,627

(22) Filed: Mar. 23, 2026

Related U.S. Application Data
(63) Continuation-in-part of application No. 30/009,430, filed on Jun. 20, 2025.
(60) Provisional application No. 63/780,079, filed on Mar. 28, 2025.

(51) Int. Cl. B65D 77/22; E05B 73/00

(52) U.S. Cl. CPC B65D 77/22; E05B 73/0023; B65D 2211/00; B65D 2255/00

(57) ABSTRACT

An anti-theft device for a package includes a housing having a main body with a transverse groove configured to receive a portion of the package, an upper cover, a lower cover, and a device hook hole extending through the housing. The device further includes at least one package-penetrating locking post movable relative to the housing to extend across the transverse groove and through an opening in the package to secure the package to the housing. In some embodiments, the device includes a lock body and a plurality of locking posts. In other embodiments, the device includes only a single package-penetrating locking post. The device can further include a lock cylinder configured to releasably engage the locking post and one or more electronic security components, including a radio-frequency security component, a radio-frequency identification component, an acousto-magnetic coil, or a magnetic rod coil.

### CROSS-REFERENCE TO RELATED APPLICATIONS

This application claims the benefit of priority under 35 U.S.C. § 119(e) to U.S. Provisional Patent Application No. 63/780,079, filed Mar. 28, 2025, and entitled “Anti-Theft Device For Blister Packages And The Like,” and further claims the benefit of priority under 35 U.S.C. § 120 to U.S. Design patent application Ser. No. 30/009,430, filed Jun. 20, 2025, the entire contents of each of which are incorporated herein by reference.

### TECHNICAL FIELD

The present application relates generally to anti-theft devices, and more specifically, some embodiments relate to anti-theft devices for blister packages and the like.

### BACKGROUND

At present, anti-theft tags are widely used in shopping malls, supermarkets, and other retail places. Such anti-theft tags are suitable for protecting products having a certain sales volume, such as beverages, clothing, bags, etc.

There are also a large number of small commodities, such as batteries, snack foods, etc., that are displayed hanging on shelving hooks. Such commodities are often encapsulated in perforated sheet-plastic packaging boxes, also known as blister packages. Blister packages rely on air holes opened in the packages to accommodate the shelving hooks. The blister packages are designed so that consumers can take the blister packages off of the shelving hooks and look at the packages up close. Some high-value goods also use this display method.

Deterring the theft of goods in hanging packages has been considered. For example, Chinese Patent Publication No. CN112081476A discloses a lock cylinder structure comprising a bottom shell and a surface shell that can be hinged to open and close to form a cover seat. The lock cylinder structure also comprises a locking assembly that is arranged in an inner cavity of the cover seat to integrally lock the bottom shell and the surface shell. An unlocking component can open the locking assembly under the effect of a magnetic unlocking device. Between the bottom shell and the surface shell is a column-shaped hanging column capable of hooking a sheet-shaped packaging box.

The above-described lock cylinder structure has several shortcomings, including the need to hook the commodity packaging box directly to the lock cylinder structure, which requires the lock cylinder structure to bear the weight of the box. Additionally, the lock cylinder structure can affect the layout of a display in which the commodity packaging box is stored.

### SUMMARY OF EMBODIMENTS

Various embodiments of the disclosed technology overcome the deficiencies in the above-mentioned background art by providing an anti-theft device conducive for use with commodity packaging boxes in the form of a blister package configured to be hung on a shelving hook. The anti-theft device is convenient for displaying various commodities on shelving hooks in retail stores, shopping malls, and other retail establishments.

According to an embodiment of the disclosed technology, an anti-theft device for a commodity packaging box comprises a seat body having a radio-frequency identification (RFID) chip and an acousto-magnetic coil or a magnetic rod coil. The seat body comprises a main body and a lock body that can be movably positioned along a first axis on the main body. A middle part of the lock body is provided with a hook-hanging hole that penetrates through the seat body along the first axis. To the right of the hook-hanging hole is a main lock post for fixing the commodity packaging box to the seat body. To the left of the hook-hanging hole is a lock-cylinder mechanism for locking the commodity packaging box to the seat body.

In one embodiment, the main body is also transversely provided with a clamping groove in which a portion of the commodity packaging box may be positioned. The clamping groove extends through the left and right sides of the main body, such that the clamping groove is open on three sides (front, left, and right). The hook-hanging hole passes through the clamping groove.

In one embodiment, the main lock post extends in a first direction from the lock body parallel to the first axis and passes through the clamping groove when the lock body moves a first predetermined distance in the first direction toward the clamping groove. The lock-cylinder mechanism comprises a secondary lock post that can be moved in the first direction with respect to the rest of the lock body. A steel needle is coupled to the secondary lock post and can move in the first direction with the secondary lock post. The steel needle projects beyond the lower end of the secondary lock post so that the steel needle can pass completely through the clamping groove when the secondary lock post moves a second predetermined distance in the first direction toward the clamping groove.

A lock cylinder can be arranged on the main body on a side of the clamping groove opposite the secondary lock post. The lock cylinder corresponds to the steel needle such that the lock cylinder can lock the steel needle in place once the lock body has moved the first predetermined distance with respect to the main body and the steel needle has moved the second predetermined distance with respect to the rest of the lock body.

In one embodiment, a thin compression column spring is positioned and extends in the first direction within an inner cavity of the secondary lock post. An upper end of the steel needle is fixedly connected to the secondary lock post. A lower end of the steel needle is positioned to extend through a shaft hole in a lower end of the inner cavity. The steel needle can thus move in the first direction along with the rest of the lock body and pass through the clamping groove when the lock body has moved the first predetermined distance with respect to the main body toward the clamping groove.

In one embodiment, a top end of the main body has an opening into which the lock body is movably positioned. The bottom end of the main body has the lock cylinder fixed thereto. The opening of the lock cylinder corresponds to the needle tip of the steel needle.

In one embodiment, the secondary lock post has an outwardly extending lip that prevents the secondary lock post from separating from the rest of the lock body. A first return spring is arranged between the secondary lock post and the main body, such that an upper end of the first return spring presses against the secondary lock post and a lower end of the first return spring presses against the main body.

As described above, a thinner compression column spring can be sleeved on the steel needle. An upper end of the thin compression column spring presses against a button portion of the steel needle. A lower end of the thin compression column spring presses against a compression column within the secondary lock post, so that the steel needle is upwardly biased with respect to the compression column.

In one embodiment, the main lock post is sleeved with a second return spring. An upper end of the second return spring presses against the main lock post. A lower end of the second return spring presses against the main body, so that the lock body is upwardly biased.

In one embodiment, the lock cylinder is three-ball conical sleeve structure.

In another embodiment of the disclosed technology, an anti-theft device for a commodity packaging box comprises a housing having a main body, an upper cover coupled to the main body, and a lower cover coupled to the main body. The main body is provided with a transverse groove for holding a portion of the commodity packaging box, with the transverse groove being open at both ends. A device hook hole extends through the housing, passing through the upper cover, the main body including the transverse groove, and the lower cover.

In one embodiment, a lock mechanism is movably positioned relative to the main body, with the lock mechanism including only a single package-penetrating locking post configured to extend across the transverse groove to a locked position. The single package-penetrating locking post can pass through an opening in the portion of the commodity packaging box held in the transverse groove. The device hook hole is positioned laterally adjacent to the single package-penetrating locking post, and no second package-penetrating locking post is positioned on an opposite lateral side of the device hook hole.

In one embodiment, the upper cover is fixed relative to the main body and defines an aperture through which the single package-penetrating locking post extends during movement to the locked position. The portion of the commodity packaging box held in the transverse groove can thereby be retained by cooperation between the single package-penetrating locking post and a surrounding portion of the housing defining the transverse groove.

In one embodiment, the single package-penetrating locking post comprises a push-button portion extending above the upper cover, a needle coupled to the push-button portion and configured to pass through the transverse groove, and a lock cylinder disposed in the lower cover. The needle is configured to releasably engage the lock cylinder when the push-button portion is depressed toward the main body.

In one embodiment, the lower cover comprises a conical protrusion extending downwardly from a bottom surface of the lower cover, and the lock cylinder is housed within the conical protrusion.

In one embodiment, the single package-penetrating locking post further comprises a compression column surrounding at least a portion of the needle and a compression column spring sleeved on the needle. An upper end of the compression column spring presses against the push-button portion and a lower end of the compression column spring presses against a lower portion of the compression column, such that the push-button portion is upwardly biased.

In one embodiment, the compression column includes a compression column lip extending around at least a portion of the compression column to prevent the compression column from completely passing into the transverse groove.

In one embodiment, the anti-theft device further comprises a radio-frequency identification (RFID) chip positioned within the housing and an acousto-magnetic coil or a magnetic rod coil operatively coupled to the RFID chip.

Various embodiments of the disclosed technology thus provide the benefit that the hook-hanging hole of the anti-theft device aligns with the air hole of the commodity packaging box. This alignment makes it convenient for both the commodity packaging box and the anti-theft device to be directly suspended together on the shelving hook. The anti-theft device therefore does not need to bear the weight of the commodity, lessening the likelihood that the anti-theft device will be damaged.

Additionally, because the hook-hanging hole of the anti-theft device aligns with the air hole of the commodity packaging box, the commodity packaging box with the anti-theft device may be suspended within a display without needing to adjust the shelving hooks. This benefit improves the shelf-utilization rate and reduces labor costs. A retail store, shopping mall, or other retail establishment may arrange the commodities in a display without needing to consider the space occupied by the anti-theft device. This benefit increases the versatility of the anti-theft device tag.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that, for clarity and ease of illustration, these drawings are not necessarily made to scale.

Some of the figures included herein illustrate various embodiments of the disclosed technology from different viewing angles. Although the accompanying descriptive text may refer to such views as “top,” “bottom,” “front,” “rear,” or “side” views, such references are merely descriptive and do not imply or require that the disclosed technology be implemented or used in a particular spatial orientation unless explicitly stated otherwise.

FIG. 1 is a top perspective view of an anti-theft device in accordance with one embodiment of the technology described herein.

FIG. 2 is a bottom perspective view of the anti-theft device of FIG. 1.

FIG. 3 is an exploded view of the anti-theft device of FIG. 1.

FIG. 4 is a cross-sectional view of the anti-theft device of FIG. 1, showing the anti-theft device in an unlocked state.

FIG. 5 is a cross-sectional view of the anti-theft device of FIG. 1, showing the anti-theft device in a locked state.

FIG. 6 is a perspective view of the anti-theft device of FIG. 1 and a blister package, with the anti-theft device separated from the blister package.

FIG. 7 is a perspective view of the anti-theft device of FIG. 1 and a blister package, with the anti-theft device placed over the blister package's hanging hole.

FIG. 8 is a perspective view of the anti-theft device of FIG. 1 and a blister package, with the anti-theft device locked to the blister package.

FIG. 9 is a perspective view of the anti-theft device of FIG. 1 and a blister package, with the anti-theft device positioned atop a magnet as part of an unlocking operation.

FIG. 10 is a perspective view of the anti-theft device of FIG. 1 and a blister package, with the anti-theft device unlocked and removed from the blister package.

FIG. 11 is a perspective view of the anti-theft device of FIG. 1 and a two-hole blister package, with the anti-theft device locked to the two-hole blister package and hung on two shelving hooks.

FIG. 12 is a perspective view of the anti-theft device of FIG. 1 and a one-hole blister package, with the anti-theft device locked to the one-hole blister package and hung on a single shelving hook.

FIG. 13 illustrates a top perspective view of the single-post design.

FIG. 14 illustrates a bottom perspective view of the single-post design.

FIG. 15 illustrates the front, rear, left, and right views of the single-post design.

FIG. 16 illustrates the top and bottom views of the single-post design.

FIG. 17 illustrates an exploded view of one embodiment of the single-post design, showing an upper cover, a push-button portion, a needle, an optional pin, a compression column, a compression column spring, a main body, a lock cylinder, a lower cover, a receiving recess, and an acousto-magnetic coil.

FIG. 18 illustrates an exploded view of another embodiment of the single-post design, wherein the anti-theft device includes a radio-frequency security component positioned between the main body and the lower cover.

FIG. 19 illustrates an exploded view of another embodiment of the single-post design, wherein the anti-theft device includes an acousto-magnetic coil and a radio-frequency identification component positioned between the main body and the lower cover.

FIG. 20 illustrates an exploded view of another embodiment of the single-post design, wherein the anti-theft device includes a radio-frequency security component and a radio-frequency identification component positioned between the main body and the lower cover.

The figures are not exhaustive and do not limit the disclosure or the disclosed embodiments to the precise form disclosed.

### DETAILED DESCRIPTION OF THE EMBODIMENTS

Embodiments of the technology disclosed herein are directed toward devices and methods for deterring the theft of retail products. More particularly, various embodiments of the technology disclosed herein relate to anti-theft devices for blister packages and the like.

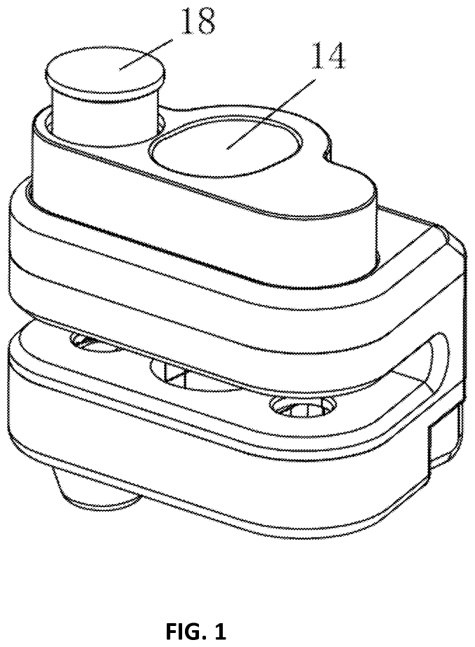

With reference to the figures, and particularly to FIGS. 1-3, there is shown an anti-theft device for a commodity packaging box, with the anti-theft device comprising a seat body having a radio frequency identification (RFID) chip and an acousto-magnetic coil or a magnetic rod coil.

More particularly, the seat body comprises a main body 8, a face cover 1 fixed at the top end of the main body 8, a bottom cover 11 fixed at the bottom end of the main body 8, and a lock body 3 that can be movably positioned along a first axis on the main body 8. The top end of the face cover 1 has an opening 1.1 in which the lock body 3 is positioned. The lock body 3 can move within the opening 1.1 along a first axis in a first direction. The lock body 3 has a stop in the form of a lip to prevent the lock body 3 from separating from the face cover 1, and more particularly to prevent the lock body 3 from completely passing through the opening 1.1.

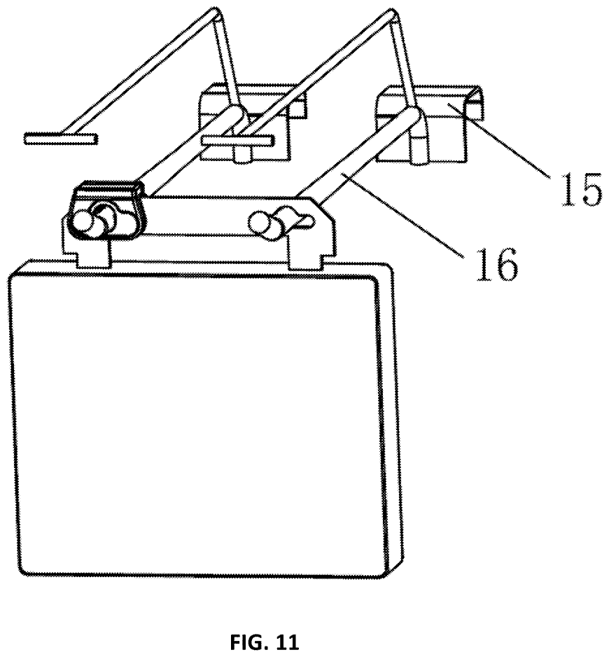

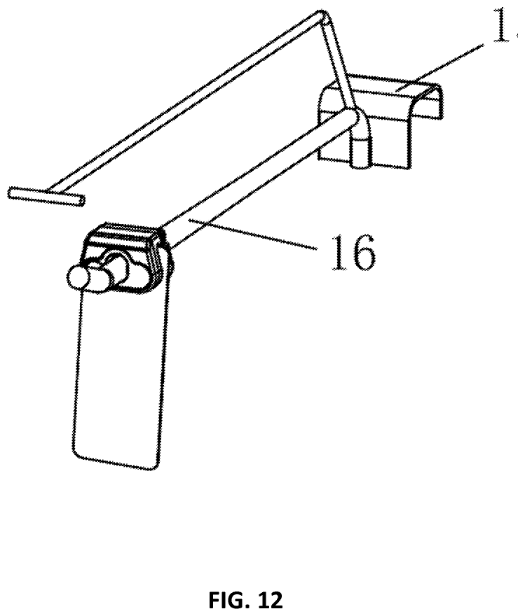

The middle part of the lock body 3 has a device hook hole 14 that penetrates through the seat body along the first axis. The device hook hole 14 is used for hanging the anti-theft device and accompanying commodity packaging box on a shelf hanging rod or shelving hook 16 (shown in FIGS. 11 and 12).

The main body 8 is transversely provided with a clamping groove 12 in which a portion of the commodity packaging box, and in particular the hook-hanging end of the commodity packaging box, may be inserted. The clamping groove 12 extends through the left and right sides of main body 8, such that the clamping groove 12 is open on three sides (front, left, and right). The device hook hole 14 extends through the clamping groove 12.

A first positioning column 8.1 is located on a left side of the main body 8, with the first positioning column 8.1 having a first inner cavity open to the clamping groove 12 via a left-side hole in the upper side of the clamping groove 12. A corresponding left-side hole is located in the lower side of the clamping groove 12, opposite the first positioning column 8.1. A second positioning column 8.2 is located on a right side of the main body 8, with the second positioning column 8.2 having a second inner cavity open to the clamping groove 12 via a right-side hole in the upper side of the clamping groove 12. A corresponding right-side hole is located in the lower side of the clamping groove 12, opposite the first positioning column 8.1. The device hook hole 14 extends through the clamping groove 12 between the first positioning column 8.1 and the second positioning column 8.2.

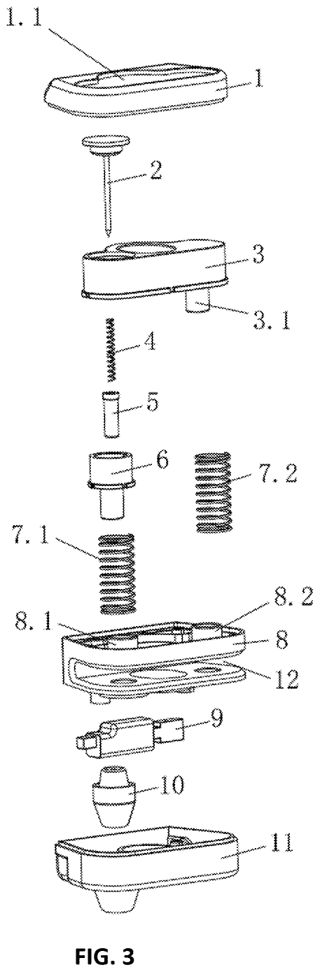

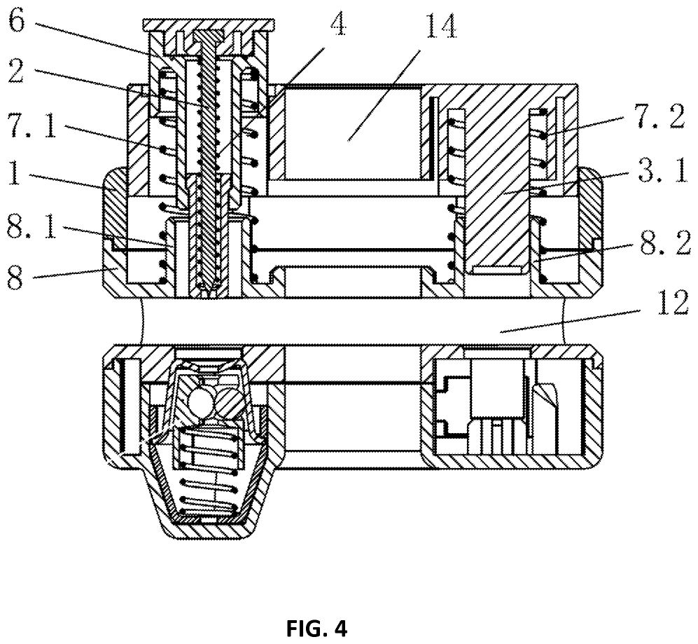

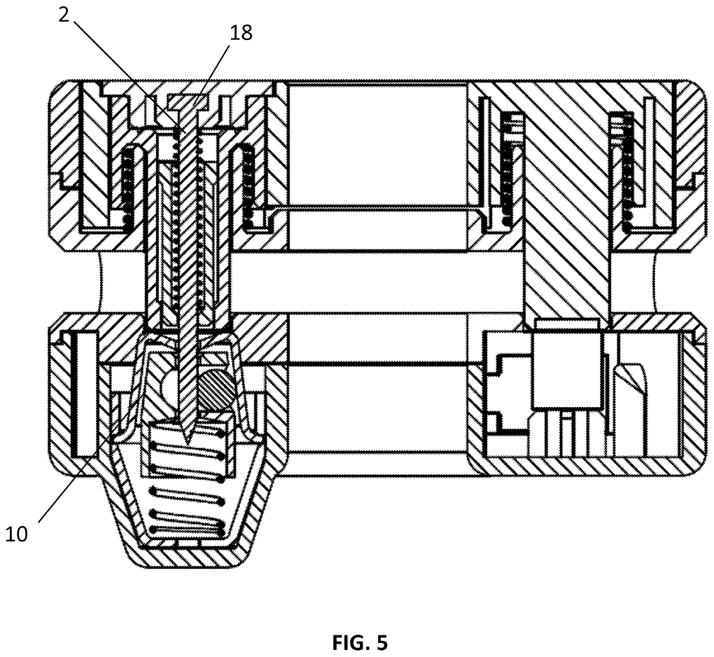

As shown in FIGS. 3-5, a lock cylinder mechanism, described more fully below, is provided on the lock body 3 to the left of the device hook hole 14. A main lock post 3.1 is provided on the lock body 3 to the right of the device hook hole 14. The top end of the main lock post 3.1 is connected to the rest of the lock body 3. A bottom end of the main lock post 3.1 extends parallel to the first axis in the first direction from the lock body 3 into the inner cavity of the second positioning column 8.2. When the lock body 3 is depressed into the main body 8 by being moved a first predetermined distance in the first direction along the first axis, the bottom end of the main lock post 3.1 passes completely through the inner cavity of the second positioning column 8.2, completely through the clamping groove 12, and into the corresponding right-side hole located in the lower side of the clamping groove 12.

As further shown in FIGS. 3-5, the lock cylinder mechanism comprises a secondary lock post 6, a compression column 5, a steel needle 2, a compression column spring 4, and a lock cylinder 10. The secondary lock post 6 can be displaced with respect to the rest of the lock body 3 in the first direction so that a lower portion of the secondary lock post 6 is ultimately positioned in the left-side hole located in the lower side of the clamping groove 12. The secondary lock post 6 has a stop in the form of an outwardly extending lip that prevents the secondary lock post 6 from separating from the rest of the lock body 3. The secondary lock post 6 thus can move in the first direction and be displaced with respect to the rest of the lock body but cannot be pulled completely through the top of the lock body 3.

A first return spring 7.1 is arranged between the secondary lock post 6 and the main body 8, such that an upper end of the first return spring 7.1 presses against the secondary lock post 6 and a lower end of the first return spring 7.1 presses against the main body 8. More particularly, the upper end of the first return spring 7.1 is sleeved over the lower portion of the secondary lock post 6. The lower end of the first return spring 7.1 is sleeved over the first positioning column 8.1. The first positioning column 8.1 and the secondary lock post 6 are coaxially arranged so that, with the first return spring 7.1 in place, the lock body 3 is biased away from the main body 8.

Similarly, the main lock post 3.1 is sleeved with a second return spring 7.2. An upper end of the second return spring 7.2 presses against the main lock post 3.1. A lower end of the second return spring 7.2 presses against the main body 8, so that the lock body 3 is upwardly biased. More particularly, the upper end of the second return spring 7.2 is sleeved over the lower portion of the main lock post 3.1. The lower end of the second return spring 7.2 is sleeved over the second positioning column 8.2. The second positioning column 8.2 and the main lock post 3.1 are coaxially arranged so that, with the second return spring 7.2 in place, the lock body 3 is biased away from the main body 8.

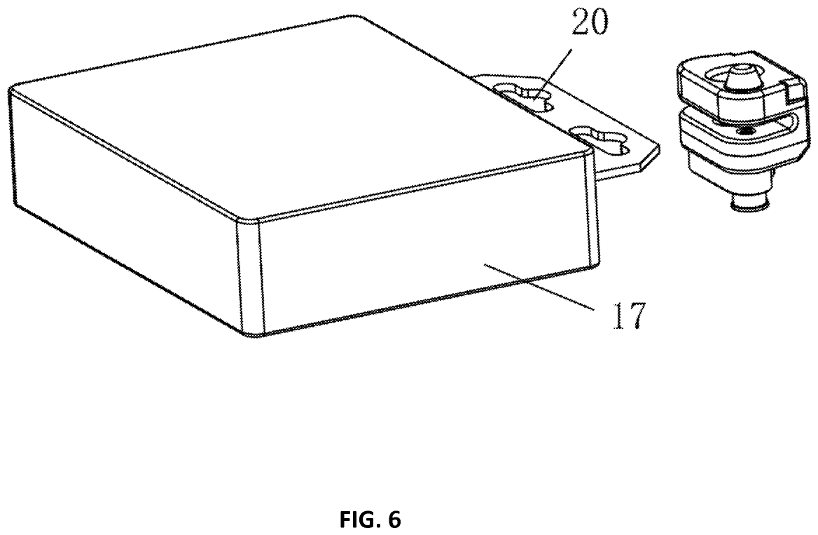

Initially, neither the main lock post 3.1 nor the secondary lock post 6 are inserted into the clamping groove 12, because the lock body 3 is biased away from the main body 8 under the action of the first return spring 7.1 and the second return spring 7.2. Because the clamping groove 12 is initially free of the main lock post 3.1 and the secondary lock post 6, the hook-hanging end of the commodity packaging box 17 (shown in FIG. 6) can be inserted into the clamping groove 12. After the hook-hanging end of the commodity packaging box 17 is inserted into the clamping groove 12, the lock body 3 can then be pressed in the first direction into the main body 8, thus inserting the main lock post 3.1 into the clamping groove 12 and through the hook-hanging end of the commodity packaging box 17. The anti-theft device thus can be initially coupled to the commodity packaging box 17 in a manner that permits the commodity packaging box 17 to be de-coupled by simply allowing the lock body 3 to spring away from the main body 8 under the action of the first return spring 7.1 and the second return spring 7.2.

The secondary lock post 6 and the first positioning column 8.1 are coaxially arranged so that the lower portion of the secondary lock post 6 is initially within the inner cavity of the first positioning column 8.1. At the same time or after the lock body 3 is pressed in the first direction into the main body 8, the secondary lock post 6 can be further pressed in the first direction through the lower end of the first positioning column 8.1 and through the clamping groove 12 to further couple the anti-theft device to the commodity packaging box 17.

Within an inner cavity of the secondary lock post 6 is the compression column 5. The compression column 5 can be moved in the first direction within the inner cavity of the secondary lock post 6 and through an opening in the bottom of the secondary lock post 6. The compression column 5 has a lip to prevent the compression column 5 from completely passing through the opening in the bottom of the secondary lock post 6 and thus separating from the secondary lock post 6.

The top end of the steel needle 2, and more particularly a button portion 18 of the steel needle 2, is fixedly connected to the secondary lock post 6 so that the steel needle 2 can move in the first direction with the secondary lock post 6. A lower part of the steel needle 2 can be moved in the first direction within a shaft hole of the compression column 5 and through an opening in a lower portion of the compression column 5. The steel needle 2 thus can project beyond the lower portion of the compression column 5 so that the steel needle 2 can pass completely through the clamping groove 12 and into the lock cylinder 10 on the lower side of the clamping groove 12.

The compression column spring 4 is sleeved over the steel needle 2. An upper end of the compression column spring 4 presses against the button portion 18 of the steel needle 2. A lower end of the compression column spring 4 presses against the lower portion of the compression column 5, so that the steel needle 2 is upwardly biased with respect to the compression column 5.

Initially, the steel needle 2 is not inserted into the clamping groove 12. When the button portion 18 of the steel needle 2 is pressed in the first direction, the secondary lock post 6, the steel needle 2, and the compression column 5 move in the first direction into the clamping groove 12. If the button portion 18 of the steel needle 2 is pressed further in the first direction, the steel needle 2 continues to move in the first direction into the lock cylinder 10, while the movement of the secondary lock post 6 and the compression column 5 is stopped by the top of the lock cylinder 10. The lower part of the steel needle 2 thus is inserted into the lock cylinder 10 upon a sufficient displacement of the button portion 18 of the steel needle 2 in the first direction (as shown in FIG. 6).

The lock cylinder 10 is located adjacent the lower side of the clamping groove 12. The steel needle 2 can pass through the clamping groove 12 and mesh with the lock cylinder 10 through an opening in the top of the lock cylinder 10. The lock cylinder 10 can be a three-ball conical sleeve structure and provide sufficient locking force to the steel needle 2 to retain the steel needle 2 within the lock cylinder 10.

As indicated in FIG. 3, a bottom cover 11 is fixed to a lower portion of the main body 8. The left side of the bottom cover 11 is provided with a recess for the lock cylinder 10.

An acousto-magnetic coil 9 is also arranged in the bottom cover 11; When the anti-theft device passes through an anti-theft antenna at a store entrance without permission, the anti-theft antenna senses the signal of the acousto-magnetic coil 9 in the anti-theft device and sends out an alarm signal.

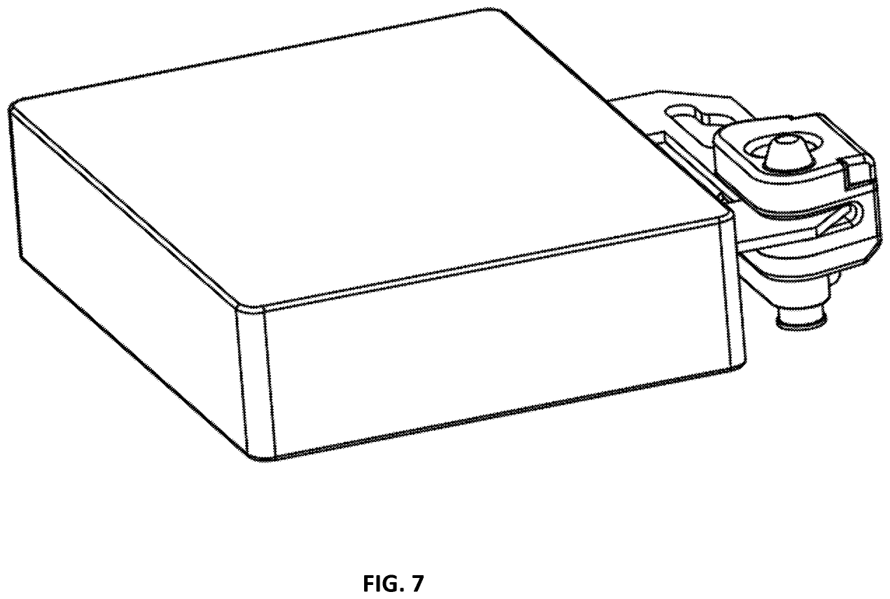

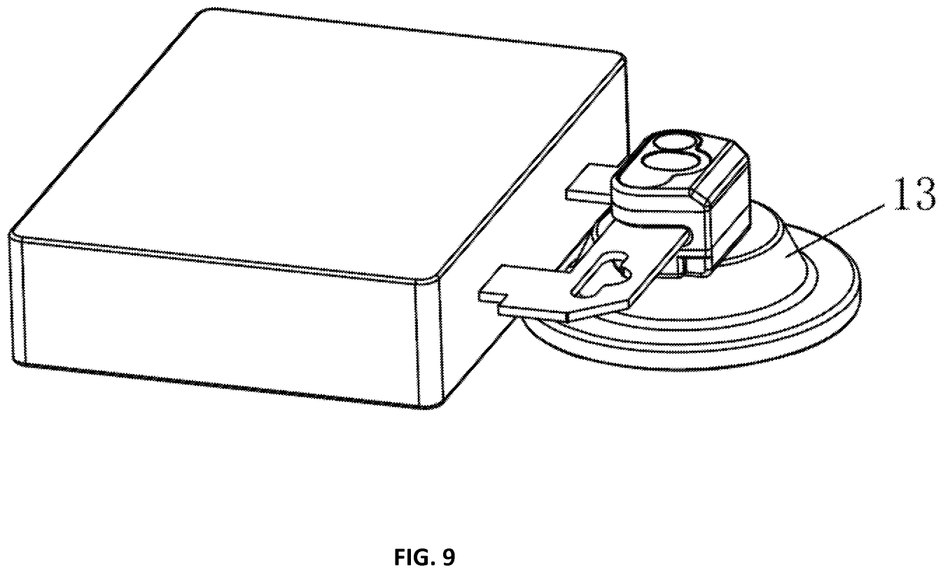

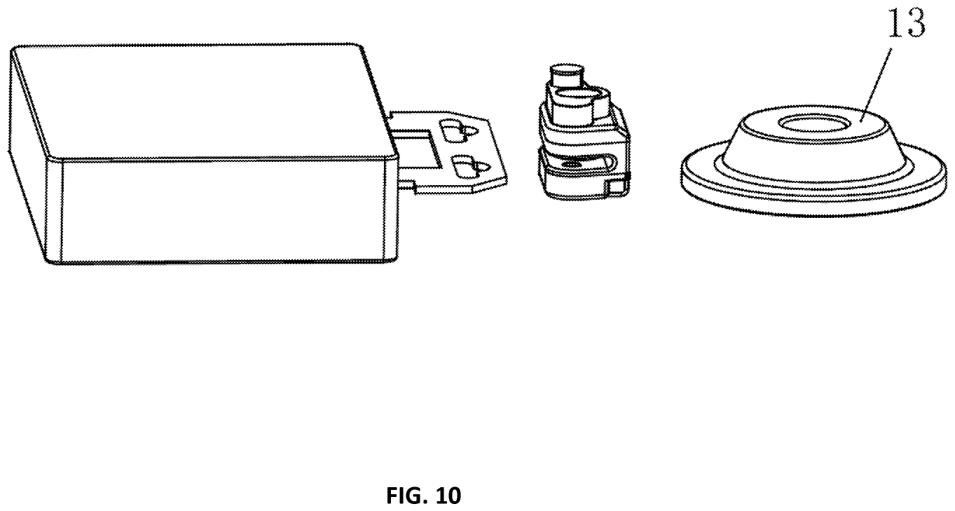

FIGS. 6 through 12 illustrate methods of using the anti-theft device. First, as shown in FIG. 6, the clamping groove 12 of the anti-theft device is aligned with the hook-hanging end of the commodity packaging box 17. Next, as shown in FIG. 7, after the hook-hanging end of the commodity packaging box 17 is inserted into the clamping groove 12, the air hole 20 on the hook-hanging end is aligned with the device hook hole 14 of the anti-theft device.

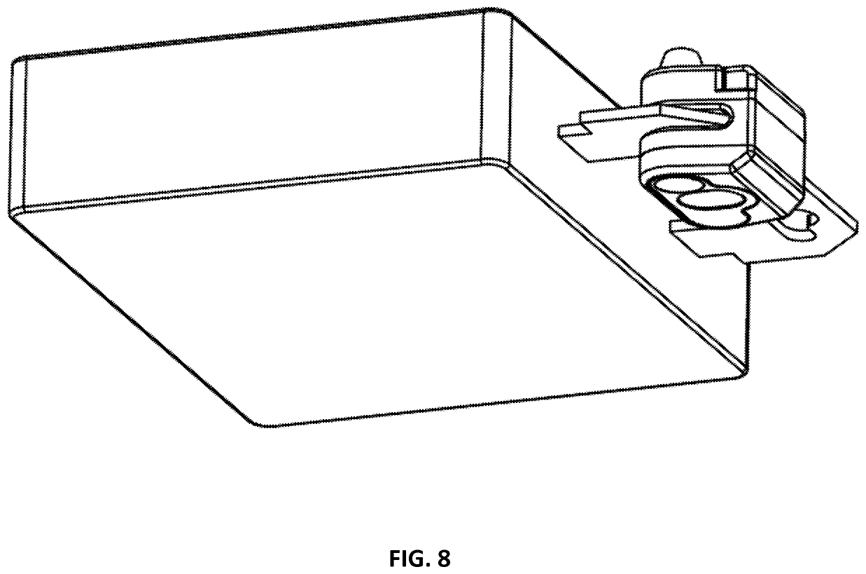

As shown in FIG. 8, the user then presses the button portion 18 of the steel needle 2, which causes the steel needle 2, the main lock post 3.1, and the secondary lock post 6 all to pass through the air hole 20 of the commodity packaging box 17. The lower end of the steel needle 2 thus is engaged with and releasably fixed to the lock cylinder. The anti-theft device is accordingly locked to the commodity packaging box 17.

In another embodiment, the user first presses the lock body 3 a first predetermined distance until the main lock post 3.1 extends completely through the clamping groove 12 and the air hole 20 of the commodity packaging box 17. This allows the user to grip the commodity packaging box 17 with the anti-theft device and to orient the air hole 20 of the commodity packaging box 17 so that the air hole 20 is properly oriented to receive the secondary lock post 6. After the air hole 20 is properly oriented, the user then presses the button portion 18 of the steel needle 2, which causes the steel needle 2 and the secondary lock post to pass through the air hole 20. The anti-theft device is accordingly locked to the commodity packaging box 17.

After the anti-theft device is locked to the commodity packaging box 17, the commodity packaging box 17, equipped with anti-theft device, can be hung on the shelf hanging rod or shelving hook 16, as shown in FIGS. 11 and 12. In some embodiments, the shelf hanging rod or shelving hook 16 can be attached to a shelf using a bracket 15, as shown in FIGS. 11 and 12, or can be attached directly to a peg board.

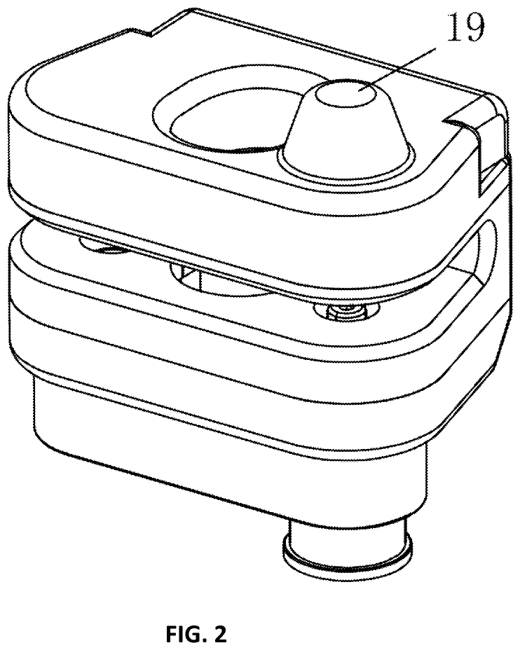

To unlock the anti-theft device from the commodity packaging box 17, the anti-theft device is aligned and brought into proximity with an unlocking device 13, which may comprise a magnet. In particular, an unlocking area 19 on the anti-theft device, shown in FIG. 2, may be aligned and brought into proximity with the unlocking device 13. The lock cylinder 10 in the anti-theft device then loosens the steel needle 2, which allows the steel needle 2, the main lock post 3.1, and the secondary lock post 6 to be withdrawn from the clamping area 12 of the anti-theft device, and thus from the air hole 20 of the commodity packaging box 17. The anti-theft device can then be separated from the commodity packaging box 17.

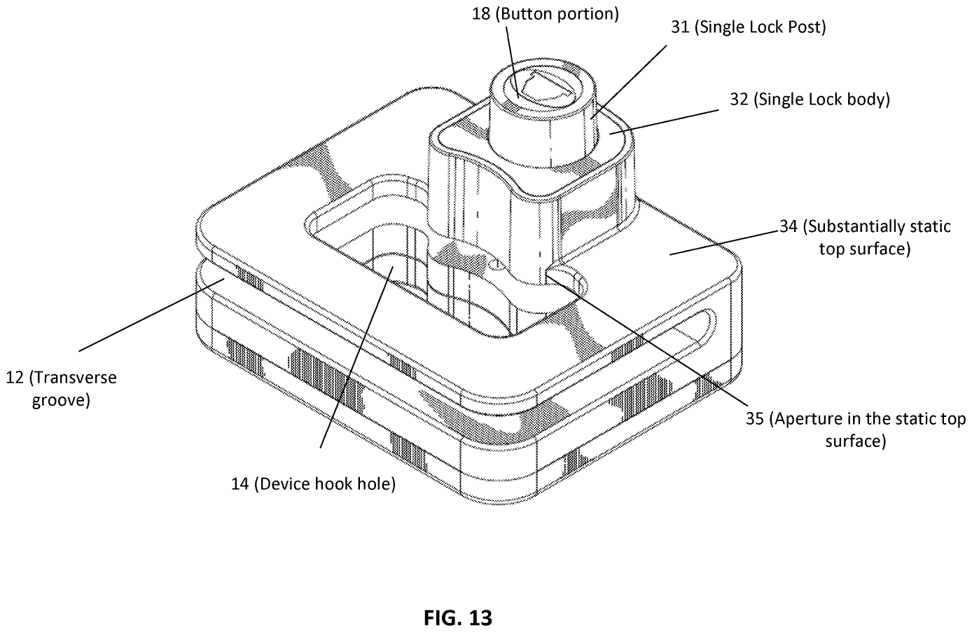

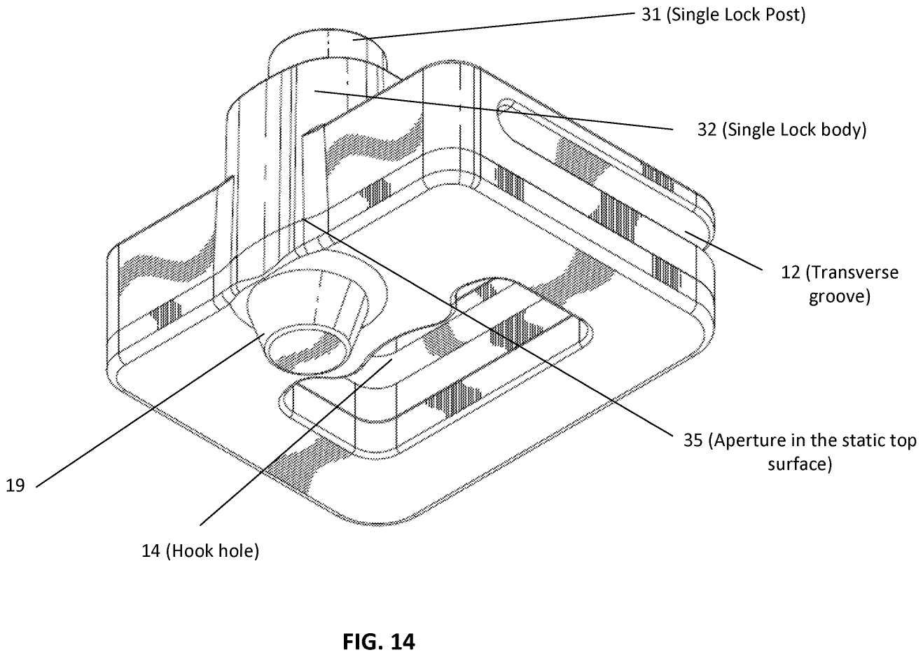

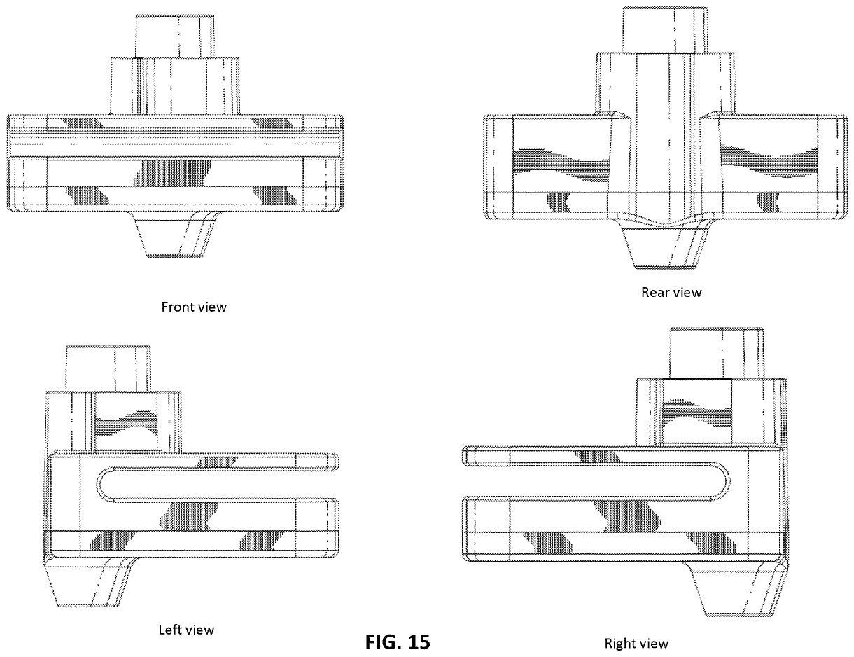

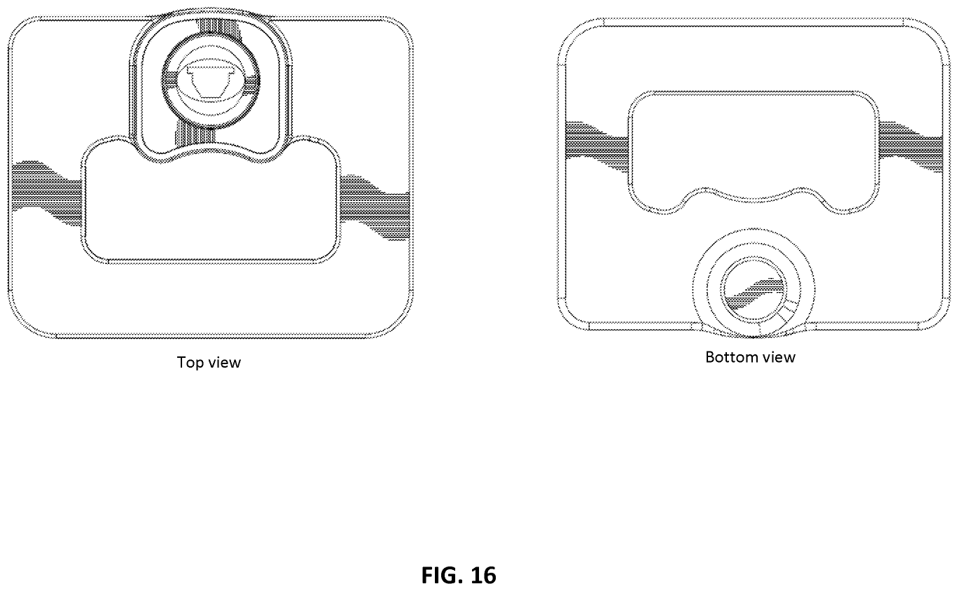

In another embodiment of the technology described herein, and with reference to FIGS. 13-16, there is shown an anti-theft device for a commodity packaging box having a single package-penetrating locking post. In this embodiment, the anti-theft device comprises a housing configured to receive and secure a portion of the commodity packaging box, and more particularly the hook-hanging end of the commodity packaging box.

More particularly, the housing can comprise a main body, an upper cover fixed relative to the main body, and a lower cover fixed relative to the main body. The housing can thus define a generally rigid outer structure within which a lock mechanism can move relative to the main body between an unlocked position and a locked position.

As shown in FIG. 13, the housing is provided with a transverse groove 12 configured to hold a portion of the commodity packaging box. In particular, the transverse groove 12 can receive the hook-hanging end of the commodity packaging box in a transverse direction. The transverse groove 12 is open at both ends so that the hook-hanging end of the commodity packaging box can be inserted laterally into the housing.

As further shown in FIGS. 13-16, a device hook hole 14 extends through the housing. More particularly, the device hook hole 14 extends through the upper cover, the main body including the transverse groove 12, and the lower cover. The device hook hole 14 can thereby receive a shelf hanging rod or shelving hook so that the anti-theft device and the commodity packaging box can be hung together in a retail display.

In the embodiment shown in FIGS. 13-16, the device hook hole 14 is positioned laterally adjacent to a single package-penetrating locking post 31. The single package-penetrating locking post 31 can be part of a lock mechanism movably positioned relative to the main body, and more particularly can be associated with a single lock body 32. The single package-penetrating locking post 31 is configured to move to a locked position in which the locking post 31 extends across the transverse groove 12.

As shown in FIG. 13, the single package-penetrating locking post 31 can comprise the only locking post configured to pass through the portion of the commodity packaging box held in the transverse groove 12. More particularly, the single package-penetrating locking post 31 can comprise the only locking member configured to extend across the transverse groove 12 and through an opening in the portion of the commodity packaging box held in the transverse groove 12. In this embodiment, no second package-penetrating locking post is positioned on an opposite lateral side of the device hook hole 14.

As further shown in FIG. 13, the upper cover includes a substantially static top surface 34 located adjacent to the device hook hole 14. The substantially static top surface 34 can be fixed relative to the main body and can define an aperture 35. The single package-penetrating locking post 31 can extend through the aperture 35 during movement to the locked position.

In some embodiments, the single lock body 32 and the single package-penetrating locking post 31 can move together relative to the main body so that, when the anti-theft device is actuated toward the locked position, the single package-penetrating locking post 31 advances through the aperture 35 and across the transverse groove 12. The single package-penetrating locking post 31 can thereby pass through an opening in the hook-hanging end of the commodity packaging box while the hook-hanging end is positioned in the transverse groove 12.

The portion of the commodity packaging box held in the transverse groove 12 can thus be retained by cooperation between the single package-penetrating locking post 31 and a surrounding portion of the housing defining the transverse groove 12. More particularly, the hook-hanging end of the commodity packaging box can be captured within the transverse groove 12 while the single package-penetrating locking post 31 passes through the opening in the commodity packaging box, thereby deterring removal of the commodity packaging box from the housing.

In this embodiment, the single package-penetrating locking post 31 is positioned laterally adjacent to the device hook hole 14 so that the anti-theft device can be secured to the commodity packaging box while preserving the function of the device hook hole 14. The device hook hole 14 and the opening in the commodity packaging box can thereby remain aligned such that the commodity packaging box and the anti-theft device can be suspended together on a shelf hanging rod or shelving hook in a retail display.

FIGS. 13-16 further show that the housing can define an unlocking area 19 on a lower side thereof. The unlocking area 19 can be aligned with an external unlocking device, such as a magnetic unlocking device, during an unlocking operation. In some embodiments, the anti-theft device can be moved into proximity with the external unlocking device at the unlocking area 19 so as to release the lock mechanism and permit withdrawal of the single package-penetrating locking post 31 from the commodity packaging box.

In some embodiments, the anti-theft device further comprises a radio-frequency identification chip positioned within the housing. The anti-theft device can further comprise an acousto-magnetic coil or a magnetic rod coil operatively coupled to the radio-frequency identification chip. When the anti-theft device passes through an anti-theft antenna at a store entrance without authorization, the anti-theft antenna can sense the signal associated with the anti-theft device and generate an alarm.

As indicated above, the embodiment shown in FIGS. 13-16 differs from the previously described embodiment in that the lock mechanism includes only a single package-penetrating locking post 31 configured to pass through the portion of the commodity packaging box held in the transverse groove 12. In this manner, the anti-theft device can provide a single-lock configuration while still permitting the commodity packaging box and the anti-theft device to be hung together from a shelving hook through the device hook hole 14.

In some embodiments of the single-lock configuration, the single package-penetrating locking post can comprise a push-button portion extending above the upper cover, a needle coupled to the push-button portion and configured to pass through the transverse groove, and a lock cylinder disposed in the lower cover. In such embodiments, the needle can be configured to releasably engage the lock cylinder when the push-button portion is depressed toward the main body.

In some embodiments, the lower cover can comprise a conical protrusion extending downwardly from a bottom surface of the lower cover, and the lock cylinder can be housed within the conical protrusion. In some embodiments, the single package-penetrating locking post can further comprise a compression column surrounding at least a portion of the needle, and a compression column spring sleeved on the needle. The compression column spring can have an upper end that presses against the push-button portion and a lower end that presses against a lower portion of the compression column, such that the push-button portion is upwardly biased.

In some embodiments, the compression column can include a compression column lip extending around at least a portion of the compression column to prevent the compression column from completely passing into the transverse groove. In this manner, the compression column, the needle, and the push-button portion can cooperate to provide a releasable single-lock mechanism. In some embodiments, the internal locking structure of the single-lock configuration can be arranged similarly to corresponding locking components described above, except that the anti-theft device includes only a single package-penetrating locking post rather than a dual-lock arrangement.

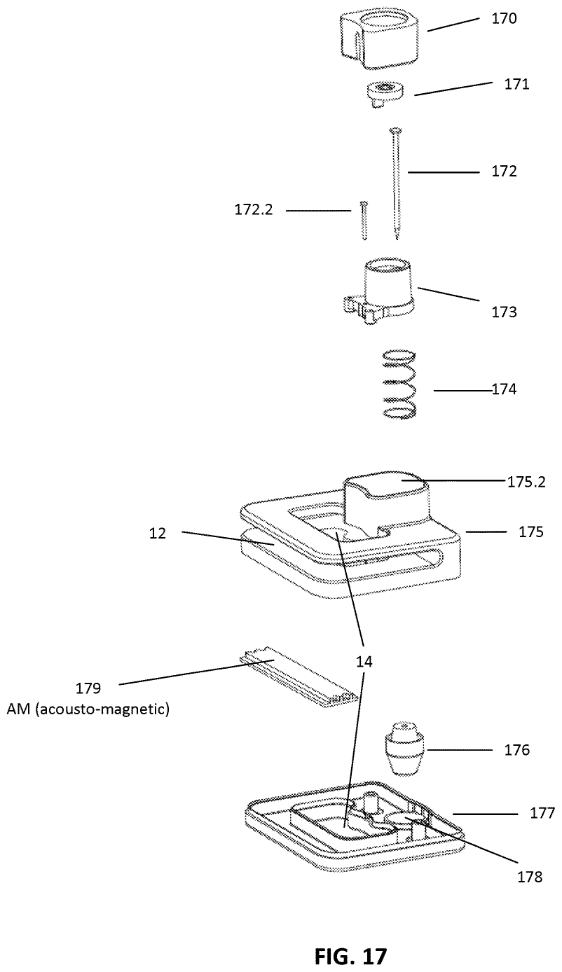

FIG. 17 is an exploded view of an embodiment of the anti-theft device described in FIGS. 13-16. As shown in FIG. 17, the example anti-theft device include an upper cover 170, a push-button portion 171, a needle 172, an optional pin 172.2, a compression column 173, a compression column spring 174, a main body 175, an aperture 175.2 formed in an upper portion of the main body 175, a lock cylinder 176, a lower cover 177, a receiving recess 178 formed in the lower cover 177, and an acousto-magnetic coil 179.

In the embodiment shown in FIG. 17, the main body 175 defines the transverse groove 12 for holding a portion of a commodity packaging box, with the transverse groove 12 being open at both ends. The device hook hole 14 extends through the anti-theft device and is positioned laterally adjacent to a single package-penetrating locking post. In this embodiment, the single package-penetrating locking post is configured to pass through the portion of the commodity packaging box held in the transverse groove 12.

The anti-theft device shown in FIG. 17 includes only a single package-penetrating locking post configured to extend across the transverse groove 12 and through an opening in the portion of the commodity packaging box held in the transverse groove 12. No second package-penetrating locking post is positioned on an opposite lateral side of the device hook hole 14. In this manner, the anti-theft device provides a single-lock configuration.

The upper cover 170 is fixed relative to the main body 175 and is positioned over the aperture 175.2. The single package-penetrating locking post extends through the aperture 175.2 during movement to a locked position. More particularly, the upper cover 170 and the aperture 175.2 cooperate to receive and guide movement of the locking structure between an unlocked position and the locked position.

The lower cover 177 is fixed to a lower side of the main body 175. The lower cover 177 includes the receiving recess 178 for receiving and positioning the lock cylinder 176. In assembled form, the lock cylinder 176 is disposed in the lower cover 177 below the transverse groove 12 such that the needle 172 may selectively engage the lock cylinder 176 during a locking operation.

The acousto-magnetic coil 179 is positioned within the housing between the main body 175 and the lower cover 177. In some embodiments, the anti-theft device may further include a radio-frequency identification chip positioned within the housing, with the acousto-magnetic coil 179 or another security component operatively coupled to the radio-frequency identification chip. In some embodiments, the acousto-magnetic coil 179 may be replaced by, or supplemented with, another security component, such as a magnetic rod coil and/or a radio-frequency component.

The single package-penetrating locking post may include the push-button portion 171 extending above the upper cover 170, the needle 172 coupled to the push-button portion 171 and configured to pass through the transverse groove 12, and the lock cylinder 176 disposed in the lower cover 177. When the push-button portion 171 is depressed toward the main body 175, the needle 172 is configured to releasably engage the lock cylinder 176.

In the embodiment shown in FIG. 17, the single package-penetrating locking post further includes the compression column 173 surrounding at least a portion of the needle 172 and the compression column spring 174 sleeved on the needle 172. The compression column spring 174 has an upper end that presses against the push-button portion 171 and a lower end that presses against a lower portion of the compression column 173, such that the push-button portion 171 is upwardly biased.

The compression column 173 is received at least partially within the aperture 175.2 and is movable relative to the main body 175 between the unlocked position and the locked position. In some embodiments, the compression column 173 includes a compression column lip configured to prevent the compression column 173 from completely passing into the transverse groove 12. The compression column 173, the needle 172, and the push-button portion 171 may thereby cooperate to provide a releasable single-lock mechanism.

The optional pin 172.2 may be coupled to the needle 172 and/or the push-button portion 171. In some embodiments, the optional pin 172.2 may be received in an opening or slot of the upper cover 170 and may help retain the locking structure, guide movement of the locking structure, limit travel of the locking structure between the unlocked position and the locked position, maintain alignment of one or more locking components, or combinations thereof. The optional pin 172.2 is not required in all embodiments.

In operation, a portion of the commodity packaging box may be received in the transverse groove 12, with an opening in the commodity packaging box aligned with the device hook hole 14 and with the needle 172. The push-button portion 171 may then be depressed so that the needle 172 passes through the opening in the commodity packaging box and releasably engages the lock cylinder 176. The portion of the commodity packaging box held in the transverse groove 12 is thereby retained by cooperation between the single package-penetrating locking post and surrounding portions of the housing defining the transverse groove 12.

Upon exposure of the unlocking area on the lower side of the anti-theft device to an external unlocking device, the lock cylinder 176 may release the needle 172, thereby permitting the compression column spring 174 to return the push-button portion 171, the needle 172, and the compression column 173 upwardly toward the unlocked position. The embodiment shown in FIG. 17 thus illustrates one example of an internal structure for the single-lock configuration described above.

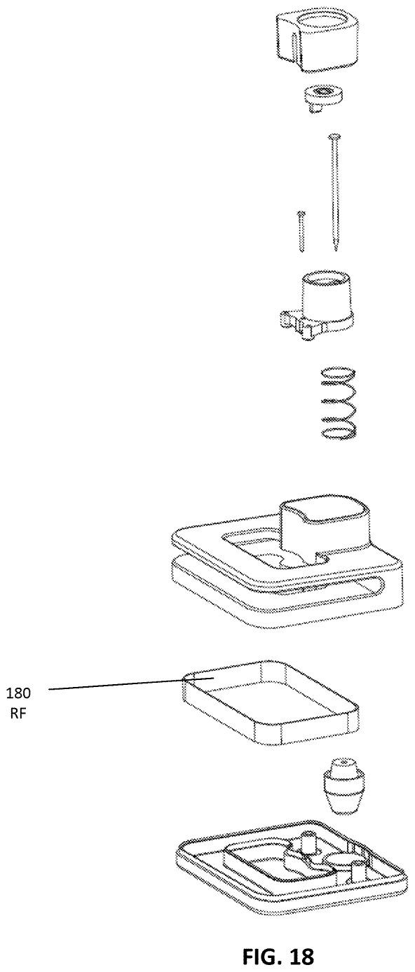

FIG. 18 is an exploded view of another embodiment of the anti-theft device, wherein the anti-theft device includes a radio-frequency security component 180 positioned between the main body 175 and the lower cover 177. Except as otherwise described, the structural and operational features of the embodiment shown in FIG. 18 can be the same as those described above with reference to FIG. 17.

In the embodiment shown in FIG. 18, the radio-frequency security component 180 can be arranged within the housing in place of the acousto-magnetic coil 179. The radio-frequency security component 180 can cooperate with a radio-frequency anti-theft system of a retail establishment so that, when the anti-theft device passes through a detection zone without authorization, an alarm can be generated. The radio-frequency security component 180 is separate from the mechanical locking structure of the anti-theft device and is not required to mechanically lock or unlock the anti-theft device.

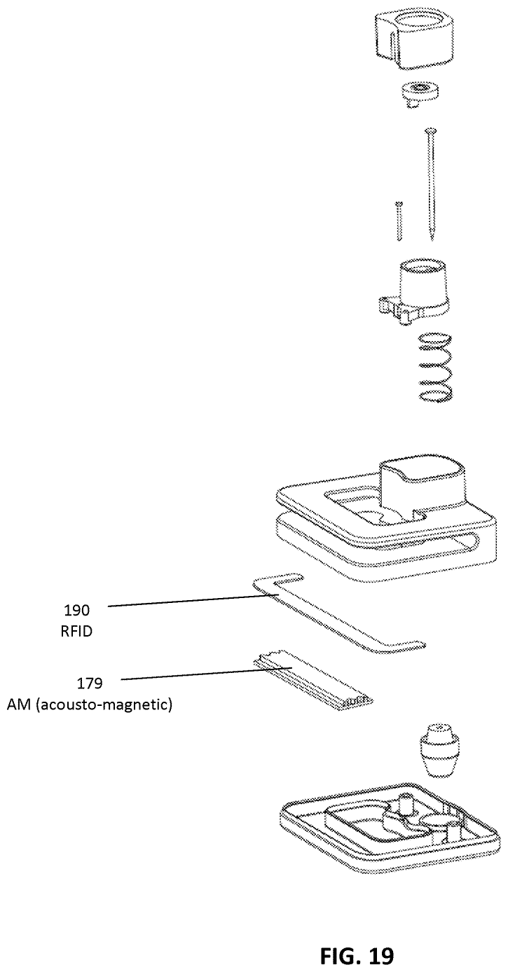

FIG. 19 is an exploded view of another embodiment of the anti-theft device, wherein the anti-theft device includes the acousto-magnetic coil 179 and a radio-frequency identification component 190 (e.g., a radio-frequency identification chip) positioned within the housing between the main body 175 and the lower cover 177. Except as otherwise described, the structural and operational features of the embodiment shown in FIG. 19 can be the same as those described above with reference to FIG. 17.

In the embodiment shown in FIG. 19, the acousto-magnetic coil 179 can cooperate with an acousto-magnetic anti-theft system to provide an alarm function, while the radio-frequency identification component 190 can provide identification and/or tracking functionality. In some embodiments, the radio-frequency identification component 190 can be used for inventory management, product identification, authentication, location tracking, or combinations thereof. The acousto-magnetic coil 179 and the radio-frequency identification component 190 can be used together in a single anti-theft device, while the mechanical locking and unlocking functions remain provided by the locking structure described above.

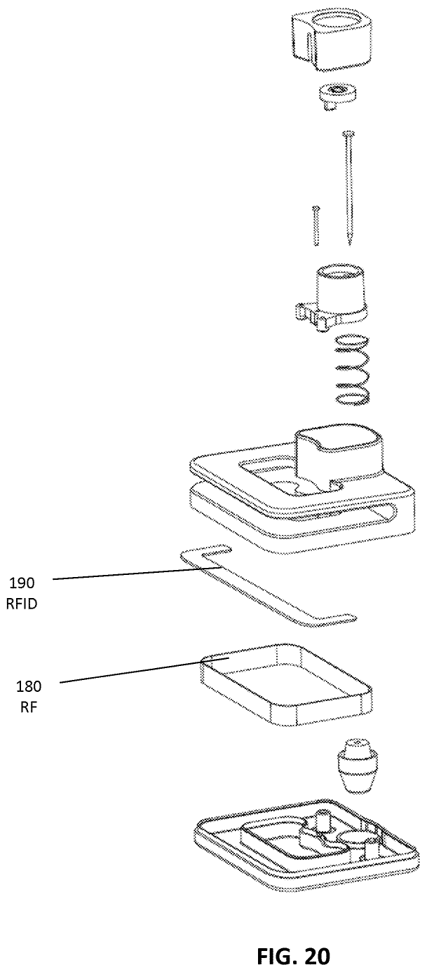

FIG. 20 is an exploded view of another embodiment of the anti-theft device, wherein the anti-theft device includes the radio-frequency security component 180 and the radio-frequency identification component 190 positioned within the housing between the main body 175 and the lower cover 177. Except as otherwise described, the structural and operational features of the embodiment shown in FIG. 20 can be the same as those described above with reference to FIG. 17.

In the embodiment shown in FIG. 20, the radio-frequency security component 180 can cooperate with a radio-frequency anti-theft system to provide an alarm function, and the radio-frequency identification component 190 can provide identification and/or tracking functionality. Accordingly, the anti-theft device can incorporate one or more electronic security components selected from an acousto-magnetic component, a radio-frequency component, and a radio-frequency identification component, depending on the needs of a particular retail environment.

The embodiments described with reference to FIGS. 13-16 are provided by way of example only. The disclosed technology is not limited to the precise configuration shown. For example, the relative size, shape, and contour of the device hook hole 14, the transverse groove 12, the single lock body 32, the single package-penetrating locking post 31, the substantially static top surface 34, the aperture 35, and the unlocking area 19 can be modified as needed for different types of commodity packaging boxes while still falling within the scope of the disclosed technology.

Particular embodiments of the disclosed technology are given in this detailed description and the accompanying drawings. The disclosed technology, however, may be implemented in many different forms and is not limited to the embodiments described in this detailed description and accompanying drawings.

What is claimed is:

1. An anti-theft device for a package, the anti-theft device comprising:
a housing including:
a main body having a transverse groove configured to receive a portion of a package, the transverse groove being open at a front side and both lateral sides;
an upper cover coupled to an upper side of the main body;
a lower cover coupled to a lower side of the main body;
a lock mechanism movably positioned relative to the main body, the lock mechanism including at least one locking post configured to extend across the transverse groove to a locked position; and
a device hook hole extending through the housing, passing through the upper cover, the main body including the transverse groove, and the lower cover,
the device hook hole being positioned adjacent the at least one locking post and configured to cooperate with a package hook hole on the portion of the package.

2. The anti-theft device of claim 1, wherein the lock mechanism comprises a lock body movably positioned on the main body, the lock body having a first peripheral portion from which a main lock post extends;
wherein the upper cover has an opening through which the lock body can project;
wherein the lock mechanism further comprises a lock cylinder mechanism configured to extend through an aperture in a second peripheral portion of the lock body opposite the first peripheral portion; and
wherein the device hook hole passes through the opening of the upper cover, a middle portion of the lock body between the first peripheral portion and the second peripheral portion, the main body including the transverse groove, and the lower cover.

3. The anti-theft device of claim 2, wherein:
the lock body is configured to move toward the main body; and
the main lock post passes through the transverse groove when the lock body has moved a first predetermined distance toward the main body.

4. The anti-theft device of claim 3, wherein the lock cylinder mechanism comprises:
a secondary lock post movably positioned in the lock body, the secondary lock post having a post opening in a lower end thereof;
a needle configured to project through the post opening in the lower end of the secondary lock post; and
a lock cylinder arranged within the housing between the transverse groove of the main body and the lower cover;
wherein the secondary lock post can be moved with respect to the lock body so that, after the lock body has moved the first predetermined distance toward the main body, the needle can further move a second predetermined distance and engage the lock cylinder.

5. The anti-theft device of claim 4, wherein the lock cylinder mechanism further comprises:
a button portion coupled to an upper end of the needle;
a compression column movable within an inner cavity of the secondary lock post and surrounding at least a portion of the needle; and
a compression column spring sleeved on the needle, the compression column spring having an upper end that presses against the button portion and a lower end that presses against a lower portion of the compression column;
wherein the compression column has a compression column lip extending around at least a portion of the compression column to prevent the compression column from completely passing through the post opening in the lower end of the secondary lock post.

6. The anti-theft device of claim 4, wherein:
the lock cylinder has a needle opening configured to receive a lower end of the needle.

7. The anti-theft device of claim 4, wherein the lock cylinder has a three-ball conical sleeve structure.

8. The anti-theft device of claim 4, further comprising:
a first return spring sleeved on the secondary lock post, and having an upper end that presses against the secondary lock post and a lower end that presses against the main body;
wherein the lock body further has a lock-body lip extending around at least a portion of the lock body to prevent the lock body from completely passing through the opening in the upper cover; and
wherein the secondary lock post has a lock-post lip extending around at least a portion of the secondary lock post to prevent the secondary lock post from completely passing through the lock body.

9. The anti-theft device of claim 8, further comprising:
a second return spring sleeved on the main lock post, and having an upper end that presses against the lock body and a lower end that presses against the main body.

10. The anti-theft device of claim 1, wherein the at least one locking post comprises only a single package-penetrating locking post configured to pass through the portion of the package held in the transverse groove.

11. The anti-theft device of claim 10, wherein the single package-penetrating locking post is the only locking member configured to extend across the transverse groove and through the package hook hole in the portion of the package held in the transverse groove.

12. The anti-theft device of claim 10, wherein the device hook hole is positioned laterally adjacent to the single package-penetrating locking post, and wherein no second package-penetrating locking post is positioned on an opposite lateral side of the device hook hole.

13. The anti-theft device of claim 10, wherein the upper cover is fixed relative to the main body and defines an aperture, and wherein the single package-penetrating locking post extends through the aperture during movement to the locked position.

14. The anti-theft device of claim 10, wherein the portion of the package held in the transverse groove is retained by cooperation between the single package-penetrating locking post and a surrounding portion of the housing defining the transverse groove.

15. The anti-theft device of claim 10, wherein the single package-penetrating locking post comprises:
a push-button portion extending above the upper cover;
a needle coupled to the push-button portion and configured to pass through the transverse groove; and
a lock cylinder disposed in the lower cover,
wherein the needle is configured to releasably engage the lock cylinder when the push-button portion is depressed toward the main body.

16. The anti-theft device of claim 15, wherein the lower cover comprises a conical protrusion extending downwardly from a bottom surface of the lower cover, and wherein the lock cylinder is housed within the conical protrusion.

17. The anti-theft device of claim 15, wherein the single package-penetrating locking post further comprises:
a compression column surrounding at least a portion of the needle; and
a compression column spring sleeved on the needle, the compression column spring having an upper end that presses against the push-button portion and a lower end that presses against a lower portion of the compression column, such that the push-button portion is upwardly biased.

18. The anti-theft device of claim 17, wherein the compression column includes a compression column lip extending around at least a portion of the compression column to prevent the compression column from completely passing into the transverse groove.

19. The anti-theft device of claim 1, further comprising:
at least one electronic security component positioned within the housing, the at least one electronic security component comprising an acousto-magnetic coil, a magnetic rod coil, a radio-frequency security component, a radio-frequency identification chip, or a combination thereof.

20. The anti-theft device of claim 19, wherein the at least one electronic security component comprises the radio-frequency security component and the radio-frequency identification chip.
